(19) United States
(12) Patent Application Publication
(10) Pub. No.: US 2019/0035042 A1
(43) Pub. Date: Jan. 31, 2019

(54) Method and System for Implementing User Biometrics as a Boarding Pass for Public Transportation

(71) Applicant: Michael J. Attar, Westhampton, NY (US)

(72) Inventor: Michael J. Attar, Westhampton, NY (US)

(21) Appl. No.: 16/146,819

(22) Filed: Sep. 28, 2018

Related U.S. Application Data
(63) Continuation-in-part of application No. 15/189,651, filed on Jun. 22, 2016.

(51) Int. Cl. G06Q 50/26; G06K 7/14; G06K 9/00; G07C 9/00

(52) U.S. Cl. CPC G06Q 50/265; G06K 7/1413; G06Q 2240/00; G06K 9/00268; G07C 9/00079; G06K 9/00067

(57) ABSTRACT

A boarding management system which utilizes a person's biometrics as a boarding-pass ticket to increase efficiency without compromising safety. The process begins with an access gate receiving entrant biometric data and an entrant electronic signal through a scanning device. The entrant biometric data is then compared against authentic biometric data for each of a plurality of user accounts to identify a matching account, thus authenticating the entrant individual. Next, boarding-pass data associated with the matching account is checked against a set of requirements to ensure that a matching timeframe and matching route identification data requirements are met. The boarding-pass data of the matching account is compared against a gate itinerary to identify shared scheduling data. If the shared scheduling data meets the set of scheduling requirements and the entrant electronic signal matches the authentic electronic signal of the matching account, then a confirmation notification is sent to the access gate.

### FIELD OF THE INVENTION

The present invention relates generally to boarding management systems for public transportation. More specifically, the present invention is a boarding management system which utilizes biometrics of an individual as a boarding pass.

### BACKGROUND OF THE INVENTION

Currently, boarding management system utilizes a physical boarding pass in conjunction with personal identification documents to identify and authenticate passengers. Such systems are implemented in various public transportation modes including, but not limited to, planes, trains, busses, ships, and other shared passenger transport services. Safety, security, and efficiency are of high importance for the aforementioned transportation modes since these services are provided for the general public. Current boarding management systems provide safety and security but are often times inefficient as a result. One way to ensure the safety and security of passengers is to authenticate each passenger credentials prior to boarding. Current boarding management systems focus quite heavily on this aspect and thus ensure safety and security for the travelers. This is achieved through the use of checkpoint personnel whose sole job is to authorize each and every individual based on acceptable credentials. While this method is effective, it is inefficient for the travelers due to the time-consuming process.

The present invention is an alternative boarding management system which solves the aforementioned problems through the use of biometric boarding passes. More specifically, the present invention utilizes an individual's biometrics as the boarding pass at an access gate in order to quickly and efficiently authenticate the individual's identity, travel privileges, and other relevant boarding information. Types of biometrics that may be used include, but are not limited to, fingerprints, face recognition, palm veins, retina recognition, hand geometry, ear lobe recognition, and other distinctive and measurable characteristics of the individual. The biometric boarding pass is tied to the individual's boarding-pass data. This allows the biometric boarding pass to be used to authorize the passenger's identity and to validate his or her boarding-pass data.

### BRIEF DESCRIPTION OF THE DRAWINGS

FIG. 1 is a system diagram of the present invention.

FIG. 2 is a flowchart depicting the overall process of the present invention.

FIG. 3 is a flowchart depicting the process if shared scheduling data does not meet the set of scheduling requirements.

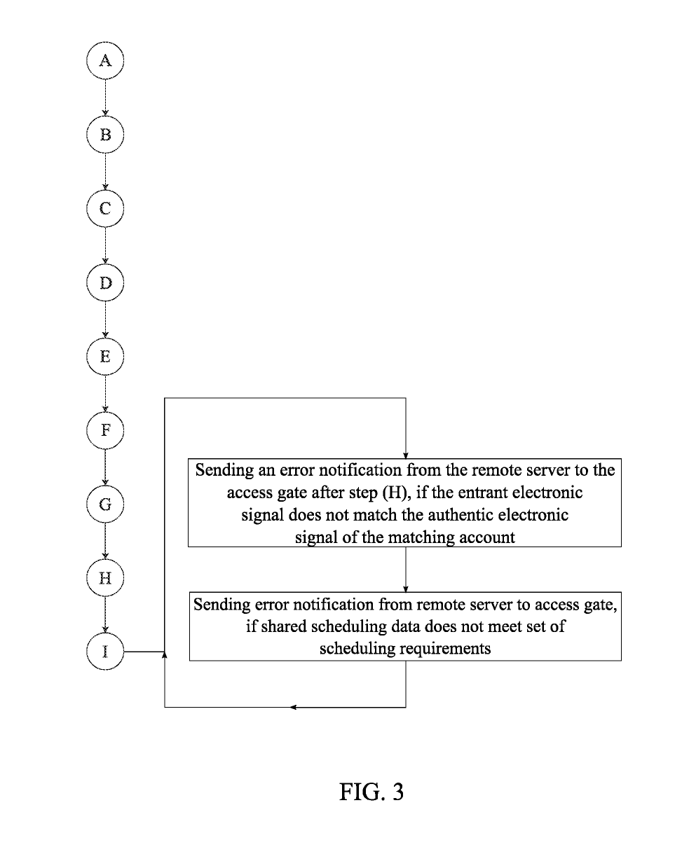

FIG. 4 is a flowchart depicting the steps necessary to register an individual's fingerprints.

FIG. 5 is a flowchart depicting the steps necessary to register an individual's facial biometrics.

FIG. 6 is a flowchart depicting the steps necessary to receive boarding-pass data through the registration kiosk.

FIG. 7 is a flowchart depicting the steps necessary to validate the identity of the individual registering at the registration kiosk.

FIG. 8 is a flowchart depicting the steps necessary to check if the matching account meets one of the scheduling requirements.

FIG. 9 is a flowchart depicting the steps necessary to check if the matching account meets one of the scheduling requirements.

FIG. 10 is a flowchart depicting the steps necessary to receive an authentic electronic signal through the registration kiosk.

FIG. 11 is a flowchart depicting the steps necessary to check if the entrant electronic signal matches the authentic electronic signal associated with the matching account.

FIG. 12 is a flowchart depicting the steps necessary to scan and identify a set of closest user accounts to the access gate based on a plurality of proximal electronic signals.

FIG. 13 is a flowchart depicting the steps necessary to scan and identify an at least one desired user account based on the authentic electronic signal corresponding to the desired user account with a detachable electronic signal scanner.

### DETAIL DESCRIPTIONS OF THE INVENTION

All illustrations of the drawings are for the purpose of describing selected versions of the present invention and are not intended to limit the scope of the present invention.

The present invention is a method for an alternative boarding management system. More specifically, the present invention is a boarding management system for public transportations that utilize an individual's biometrics as a boarding-pass. Biometrics are associated with human physical and/or behavioral characteristics. Biometrics are used to verify an identity of an individual because these physical and/or behavioral characteristics are unique to each person. Types of biometrics that may be used for the present invention include, but are not limited to, fingerprint characteristics, face geometry, earlobe geometry, voice print, vein configurations, retina geometry, and other distinctive and measurable characteristics. The present invention associates the individual's boarding-pass information to his or her biometrics. Resultantly, all that is required during boarding procedures is to capture the individual's biometrics, thus decreasing the boarding time required per passenger without compromising the overall safety and security. Additionally, the present invention also scans and stores the individual's electronic signal in order to add another level of verification during boarding procedures. An electronic signal is any electromagnetic radiation being emitted by the electronic devices being held by the individual. Type of electronic devices include, but are not limited to, smartphones, laptops, tablets, cell phones, smart watches, wireless headphones, and other similar electronic devices. The present invention may be used for a variety of transportation services including, but not limited to, planes, trains, busses, ships, and other shared passenger transport services.

The present invention comprises a system and a method that provide a novel boarding management system. The method is a software application executed by the system of the present invention for a plurality of user accounts. Each of the user accounts represents a passenger and is associated with authentic biometric data, an at least one authentic electronic signal, and boarding-pass data (Step A). The authentic biometric data corresponds to the physical and/or behavioral characteristics of the corresponding passenger. The boarding-pass data includes particulars of the passenger and the route such as seat, row, route number, vehicle type, confirmation number, passenger name, amount paid, and other similar information. For the authentic electronic signal, each user account is further associated with an at least one portable electronic device, wherein the portable electronic device emits the authentic electronic signal (Step B). The authentic electronic signal is electromagnetic radiation with a specific frequency. Additionally, each of the plurality of user accounts is provided with user identification (ID) information. The user ID information includes, but is not limited to, name, address, contact information, and other similar information. The user ID information is entered by the passenger when he or she purchases their ticket, essentially creating a user account with the present invention.

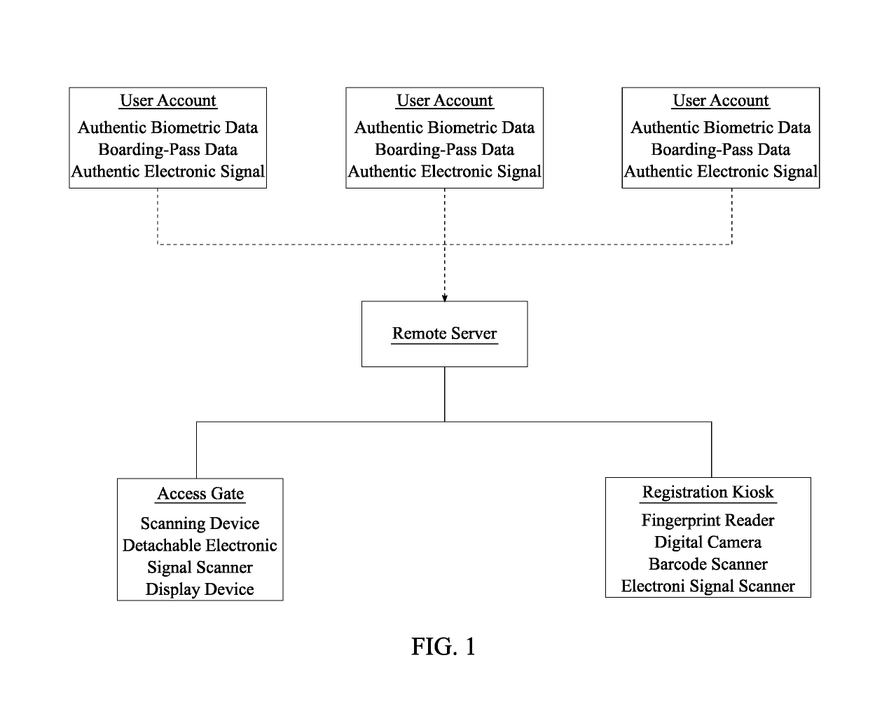

Referring to FIG. 1, the system of the present invention comprises the physical components required to execute the method. One of the main components is an at least one access gate. The access gate refers to the system(s) and apparatuses used to process individuals prior to boarding, which may include a physical gate/door. Processing may include, but is not limited to, verifying boarding ticket/information, verifying personal identity, and performing other similar pre-traveling processes. The access gate may be automatic or manned by security personnel. Additionally, the access gate includes an at least one scanning device and is associated with a gate itinerary and a set of scheduling requirements (Step C). The scanning device is used to scan/capture the individual's biometrics as well as scan/capture individual's electronic signal. A variety of devices may be used for the scanning device including, but not limited to, a digital camera, a fingerprint reader, a signal detector device, and other similar devices. The gate itinerary includes information about the transportation services offered at the access gate such as vehicle type, departure times, arrival times, vehicle identification, operating identify, and other pertinent information related to the transportation services. Two import pieces of information included in the gate itinerary are a departure time for a scheduled transport route and route ID data for said scheduled transport route. Route ID data may be implemented in the form of a number, a word, a sentence, lettering, or a combination thereof. The scheduled transport route refers to a route or a flight that is being offered by the transportation services utilizing the present invention. The set of scheduling requirements is a multitude of criteria that a user account from the plurality of user accounts must meet in order to pass the access gate. Other main components include an at least one remote server and a registration kiosk. The remote server manages the gate itinerary and the plurality of user accounts. The remote server is communicably coupled to the access gate and the registration kiosk. The registration kiosk allows passengers to register with the present invention.

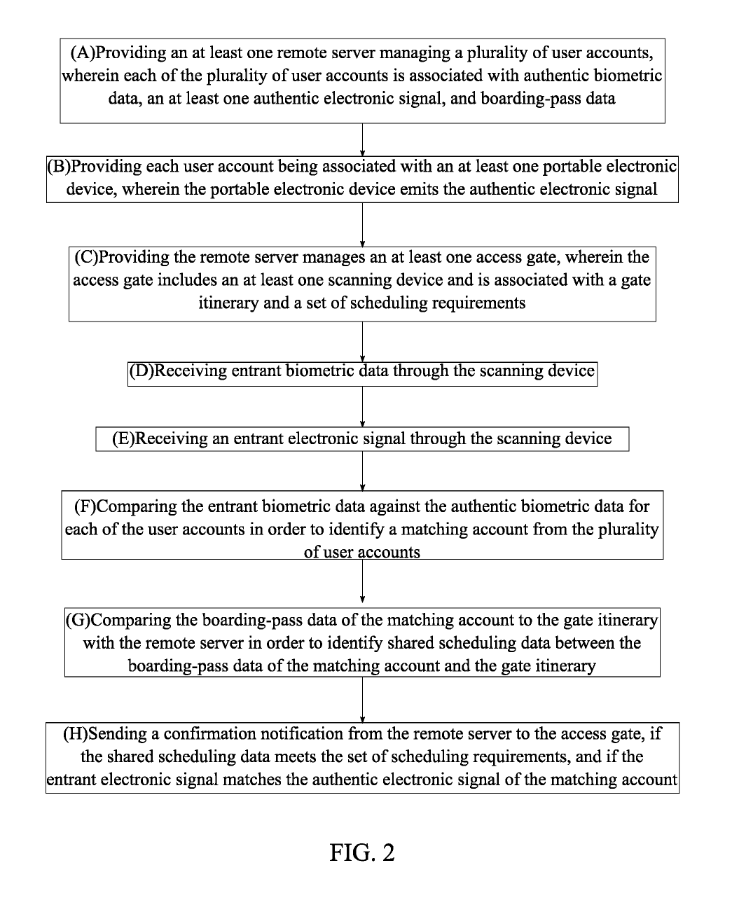

Referring to FIG. 2, the overall process of the present invention begins with the access gate receiving entrant biometric data through the scanning device (Step D). Additionally, the access gate receiving an entrant electronic signal through the scanning device. This step represents an entrant individual submitting his or her biometrics to the access gate, thus requesting passage through the access gate. The entrant electronic signal is used to verify the biometrics of the entrant individual. The entrant biometric data and the entrant electronic signal are then sent from the access gate to the remote server for authentication and analysis. Upon receival, first, the remote server compares the entrant biometric data against the authentic biometric data for each of the user accounts in order to identify a matching account from the plurality of user accounts (Step F). This step is implemented in order to authenticate the identity of the entrant individual, one of the main purposes of a boarding management system. In one embodiment, due to natural inconsistencies, a complete identical match for the biometric data is not required to identify the matching account, but instead a minimum similarity threshold is required; the minimum similarity threshold is pre-set by the managing entities of the transportation services. If the identity of the entrant individual is validated, i.e. the matching account is identified, then the boarding-pass data associated with the matching account is analyzed. The boarding-pass data of the matching account is compared to the gate itinerary with the remote server in order to identify shared scheduling data between the boarding-pass data of the matching account and the gate itinerary (Step G). The shared scheduling data is a set of similar elements between the boarding-pass data of the matching account and the gate itinerary. Examples of similar elements include, but are not limited to, route number, departure time, gate number, and other similar information. In general, step G ensures that the matching account bought a ticket for the correct scheduled transport route. If the shared scheduling data meets the set of scheduling requirements, then the entrant electronic signal is analyzed. Specifically, the entrant electronic signal is compared against the authentic electronic signal of the matching account by the remote server to determine a degree of similarity, as electronic signals may vary. If the entrant electronic signal matches the authentic electronic signal of the matching account and the shared scheduling data meets the set of scheduling requirements, then a a confirmation notification is sent from the remote server to the access gate (Step H). The set of scheduling requirements is determined by the scheduled transport route that is currently boarding at the access gate when the entrant individual requests permission to pass. The confirmation notification is sent to the access gate in order to grant passage for the entrant individual through access gate. Alternatively, if the shared scheduling data does not meet the set of scheduling requirements, then an error notification is sent from the remote server to the access gate after Step H. Additionally, the error notification is sent from the remote server to the access if the entrant electronic signal does not match the authentic electronic signal of the matching account. The error notification signals to the access gate to not allow the entrant individual to pass through the access gate.

In one embodiment of the present invention, the access gate is fully automated and does not require an operator. In this embodiment, if the confirmation notification is sent from the remote server to the access gate, then the access gate physically opens and allows a single individual to pass through. Alternatively, if the error notification is sent from the remote server to the access gate, then the access gate does not open and displays an error message. In another embodiment of the present invention, the access gate is managed by an operator. In this embodiment, the access gate displays either the confirmation notification or the error notification and the operator acts accordingly.

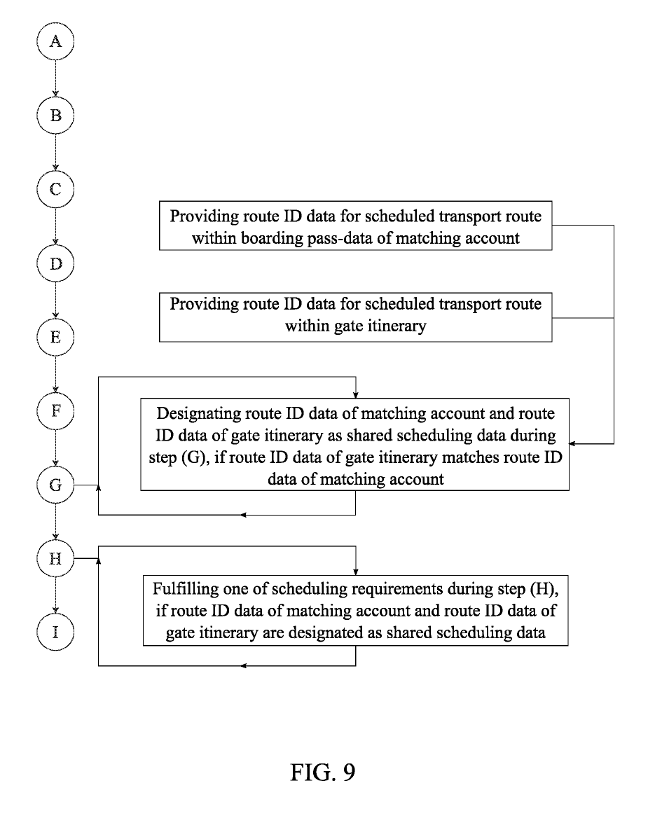

Referring to FIG. 9, one of the scheduling requirements is a matching transport route. More specifically, the route from the boarding-pass data of the matching account matches the route from the gate itinerary. First, the route ID for the scheduled transport route is extracted from the boarding-pass data of the matching account. Next, the route ID data of the matching account is compared to the route ID of the gate itinerary. If the route ID data of the gate itinerary matches the route ID data of the matching account, then the route ID data of the matching account and the route ID data of the gate itinerary are designated as the shared scheduling data during Step G. The shared scheduling data is then analyzed to ensure that all the necessary scheduling requirements are met. If the route ID data of the matching account and the route ID data of the gate itinerary are designated as the shared scheduling data, then one of the scheduling requirements is fulfilled, more specifically the matching transport route requirement. In the simplest embodiment of the present invention, this is accomplished through a single number, word, or variable that is compared during Step G.

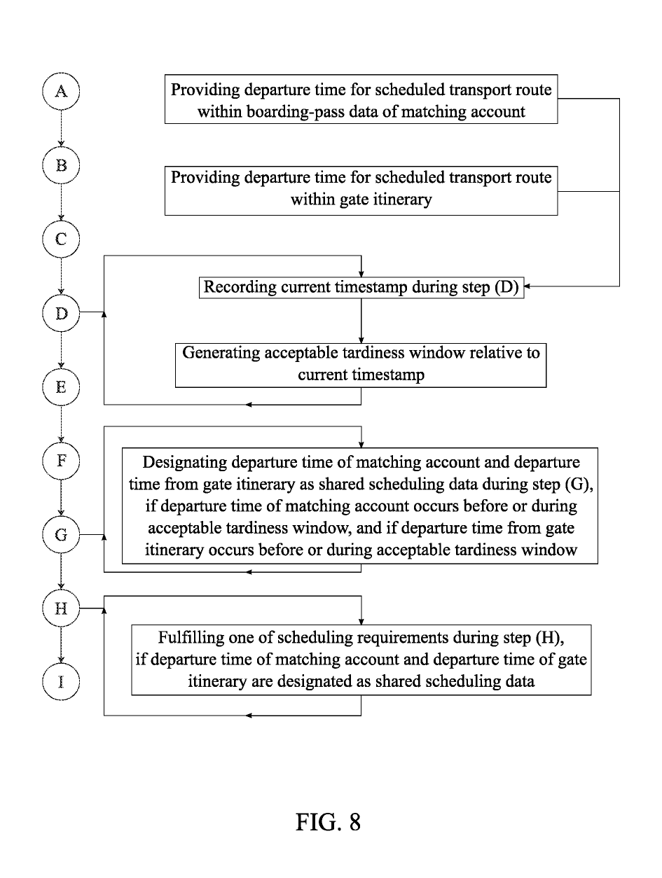

Referring to FIG. 8, another scheduling requirement is a matching timeframe. In general, the matching timeframe checks that the entrant individual arrives on time and for the correct departure time. Information necessary to check this requirement includes a departure time for the scheduled transport route within the boarding-pass data of the matching account and a departure time for the scheduled transport route within the gate itinerary. First, a current timestamp is recorded during Step D. Next, the system generates an acceptable tardiness window relative to the current timestamp in order to allow for a certain degree of lateness. If the departure time of the matching account occurs before or during the acceptable tardiness, and if the departure time of the gate itinerary occurs before or during the acceptable tardiness window, then the departure time of the matching account and the departure time of the gate itinerary are designated as the shared scheduling data during Step G. If the departure time of the matching account and the departure time of the gate itinerary are designated as the shared scheduling data, then one of the scheduling requirements is fulfilled, more specifically the matching timeframe requirement.

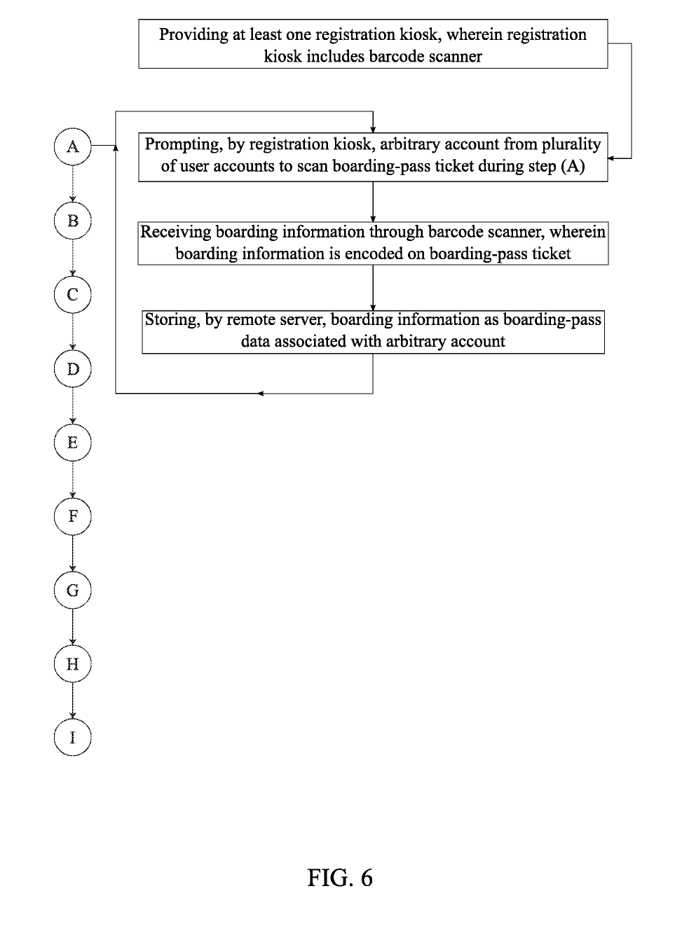

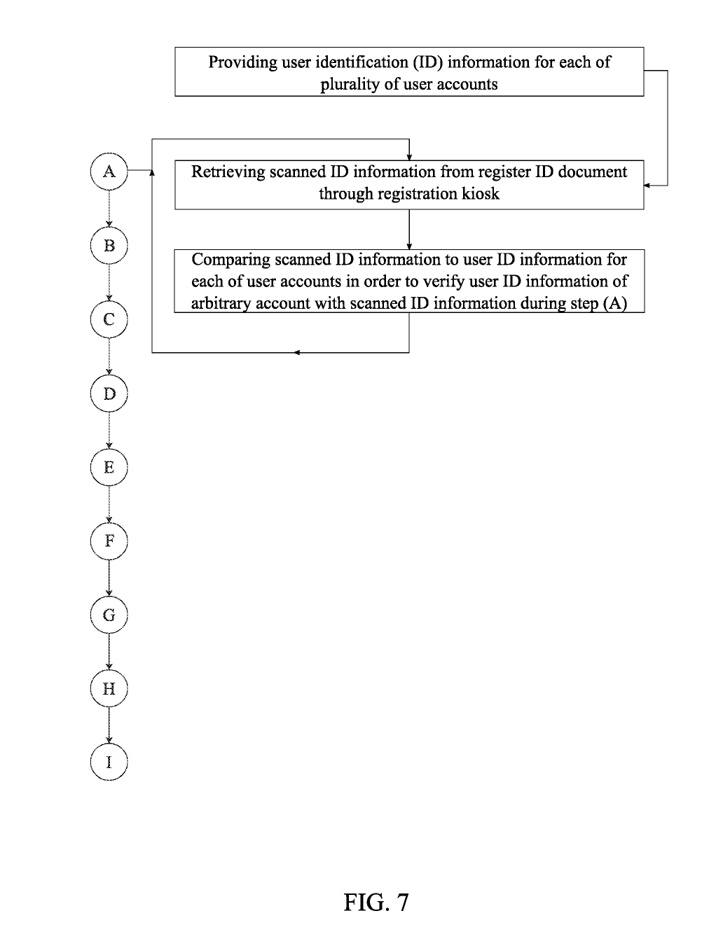

Prior to boarding procedures at the access gate, each of the user accounts is required to register with the present invention. Registration includes submitting the required biometrics and entering/submitting boarding-pass data. In one embodiment of the present invention, each of the user accounts is allowed to register through the registration kiosk. The registration kiosk may be equipped with a fingerprint reader, a digital camera, and a barcode scanner. Referring to FIG. 6, the registration process begins with the registration kiosk prompting an arbitrary account from the plurality of user accounts to scan a boarding-pass ticket during Step A. The arbitrary account is used as a proxy in order to represent any one of the plurality of user accounts. This process is similar to any modern barcode systems as the individual simply positions a barcode of the boarding-pass ticket in front of the scanner. Next, the registration kiosk receives boarding information through the barcode scanner, wherein the boarding information is encoded on the boarding-pass ticket. Boarding information includes, but is not limited to, route number, confirmation number, identity of passenger, seat number, departure time, and any other information regularly used by transportation services. The boarding information is then stored by the remote server as the boarding-pass data associated with the arbitrary account. Referring to FIG. 7, the boarding information is also used to retrieve user ID information associated with the arbitrary account from the remote server. More specifically, the user ID information that is entered and used to purchase the associated boarding-pass ticket. To validate the identity of the individual that is registering, the individual is prompted by the registration kiosk to scan/enter a registered ID document such as a passport or a driver's license during Step A. Once the individual scans/enters the registered ID document, scanned ID information is retrieved from the registered ID document through the registration kiosk. The scanned ID information is then compared to the user ID information for each of the user accounts in order to verify the user ID information of the arbitrary account with the scanned ID information. In one embodiment of the present invention, the registration kiosk is managed by an operator that validates the identity of the arbitrary account as well for additional security.

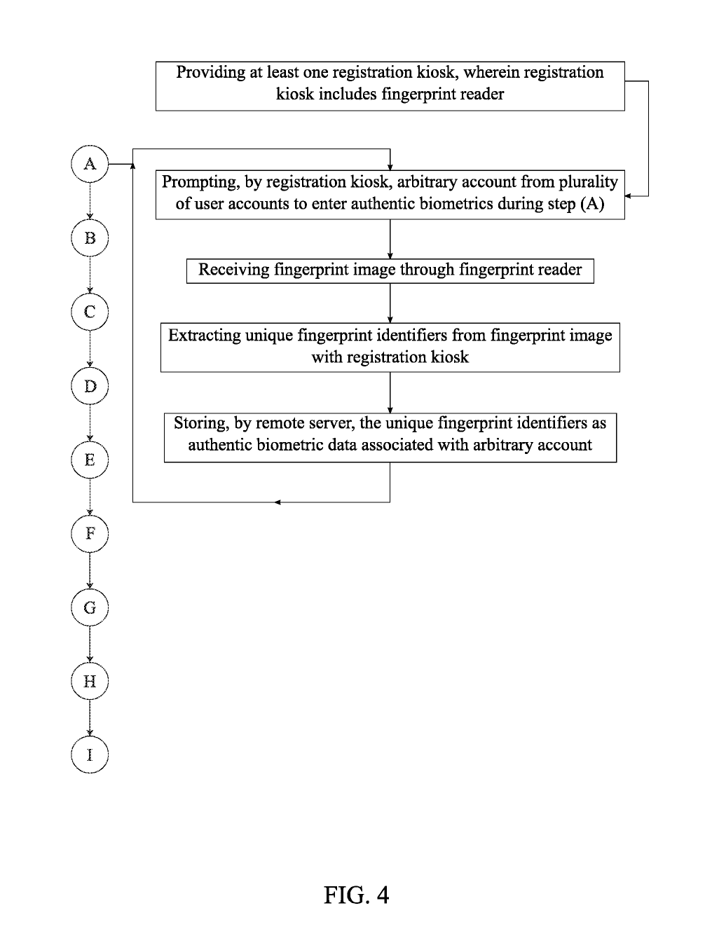

Referring to FIG. 4, the process for obtaining biometrics begins with the registration kiosk as it prompts the arbitrary account to enter authentic biometrics during Step A. One of the main biometrics that may be used by the present invention is an individual's fingerprints. Once prompted, the individual places his or her fingers onto the fingerprint scanner. This allows the present invention to receive a fingerprint image through the fingerprint reader. Next, unique fingerprint identifiers are extracted from the fingerprint image with the registration kiosk. Unique fingerprint identifiers comprise the position, orientation, and the shape of ridges, valleys, as well as the physical difference between the two. A variety of methods may be used to extract the unique fingerprint identifiers. Once extracted, the unique fingerprint identifiers are stored, by the remote server, as the authentic biometric data associated with the arbitrary account.

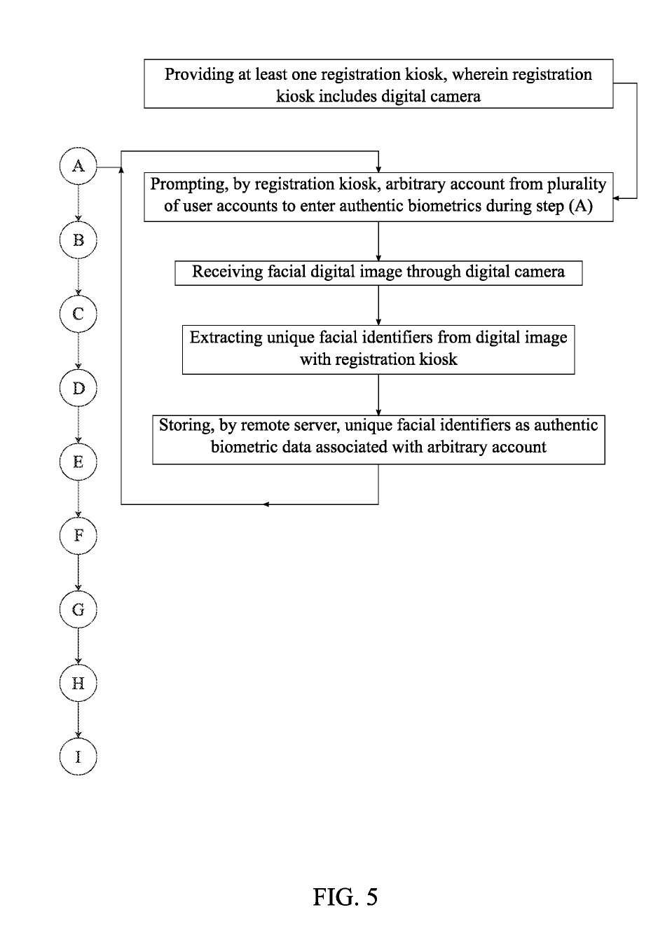

Referring to FIG. 5, another main biometric that may be used by the present invention is facial geometry. Similar to the fingerprint biometric process, the arbitrary account is first prompted, by the registration kiosk, to enter authentic biometrics during Step A. Once prompted, the user positions his or her face directly in front of the digital camera and stand still until a picture is taken. This allows the present invention to receive a facial digital image through the digital camera. Next, unique facial identifiers are extracted from the digital image with the registration kiosk. Unique facial identifiers comprise various variables of a person's face, such as length and width of the nose, cheek shape, depth of eye sockets, lip width and length, and other similar features. The unique facial identifiers are then stored, by the remote server, as the authentic biometric data associated with the arbitrary account. In alternative embodiments, the registration kiosk is equipped with the necessary devices to measure and receive alternative types of biometrics including, but not limited to, earlobe geometry, voice print, vein configurations, and retina geometry.

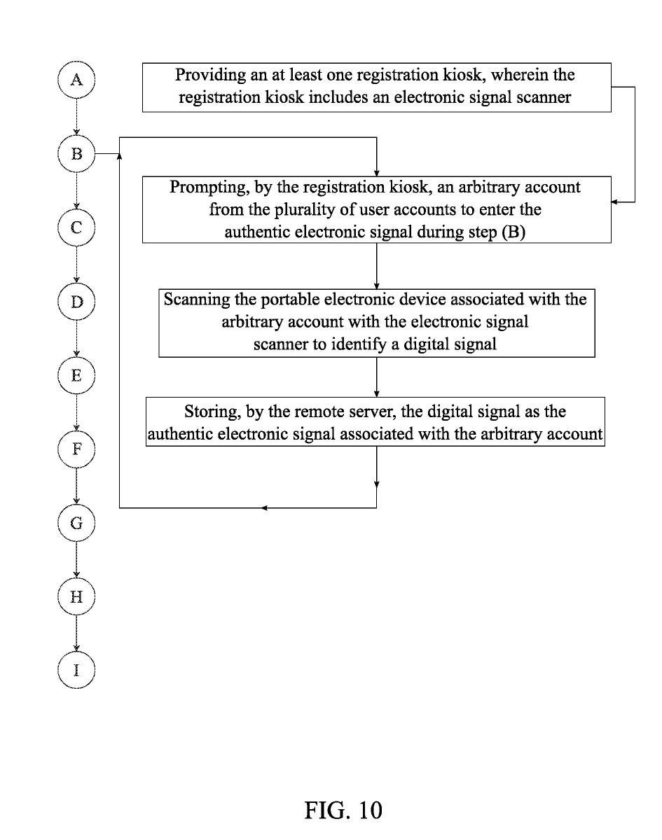

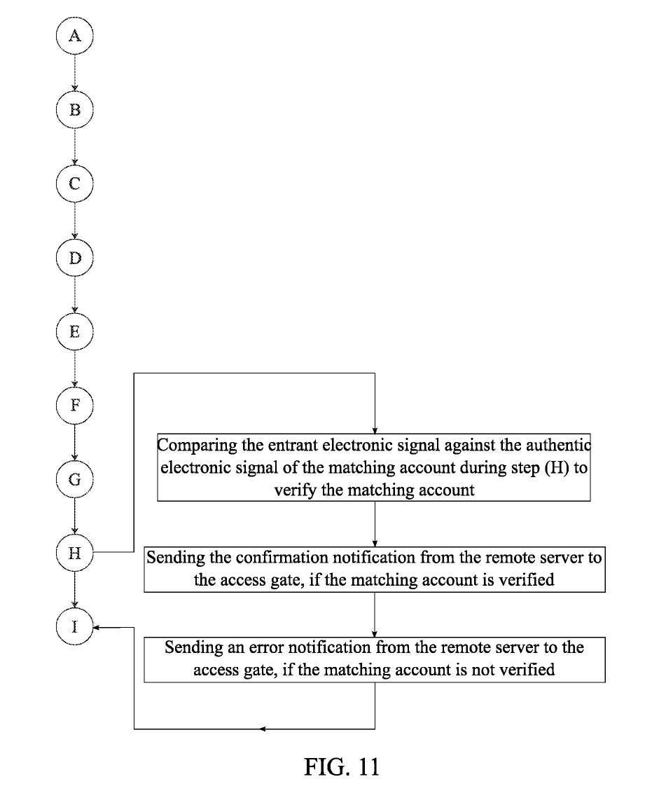

Referring to FIG. 10, registration also includes registering the electronic sign of the individual. For this, the registration kiosk includes an electronic signal scanner. The electronic signal scanner detects wireless signals being emitted from a device or a predetermined area. Type of signals that the electronic signal scanner may identify includes, but is not limited to, AM and FM radio, television, cellular phones, Wi-Fi, satellite signals, two-way radios, and Bluetooth. The electronic signal scanner may detect various types of characteristics of the aforementioned signals including, but not limited to, frequency, amplitude, modulation degree, and other similar features of a signals. For obtaining the authentic electronic signal for the arbitrary account, the arbitrary account is first prompted, by the registration kiosk, to enter the authentic electronic signal during Step B. Once prompted, the user positions his or her body within a preset distance of the electronic signal scanner. This allows the electronic signal scanner to scan the at least one portable electronic device(s) being held or carried by the individual for a digital signal, i.e. the at least one portable electronic device associated with the arbitrary account. The digital signal is then stored by the remote server as the authentic electronic signal associated with the arbitrary account. This provides an additional layer of security and verification during boarding processes. Specifically, during Step H, the entrant electronic signal is compared against the authentic electronic signal of the matching account to verify the identity of the individual. If the matching account is verified, i.e. the entrant electronic signal matches the authentic electronic signal of the matching account, then the confirmation notification is sent from the remote server to the access gate, allowing the individual to proceed. If the matching account is not verified, i.e. the entrant electronic signal does not match the authentic electronic signal of the matching account, then the error notification is sent from the remote server to the access gate, preventing the individual from passing the access gate as seen in FIG. 11.

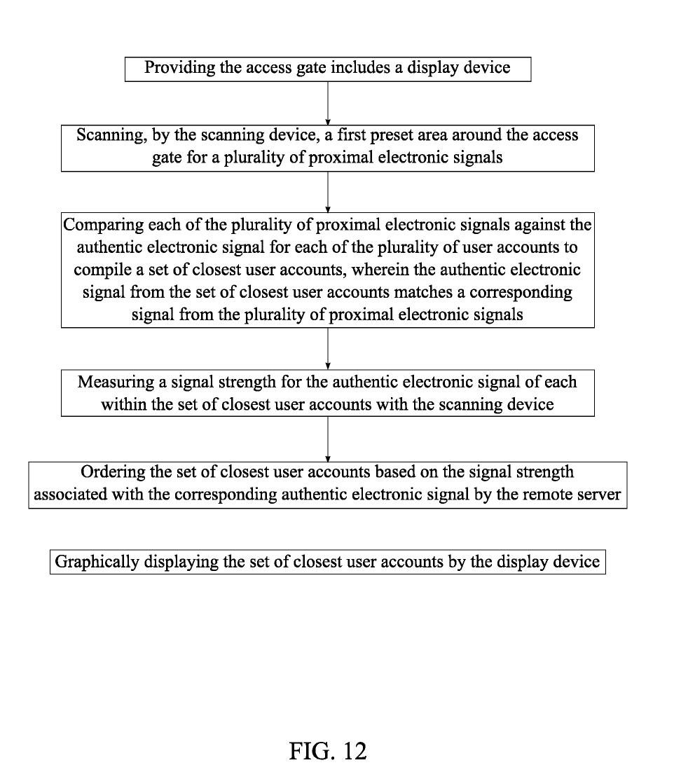

Referring to FIG. 12, the electronic signal detection of the present invention provides a variety of additional benefits in addition to verification purposes. One particular benefit includes crowd management around the access gate. In one embodiment of the present invention, the access includes a display device. The display device allows the present invention to convey to a security personal a list of nearby passengers. This information may be used to relay individuals to appropriate terminals, order individuals in a specific and a more efficient processing order, identify questionable individuals, identify possible target individuals. For this, the scanning device continuously scans a first preset area around the access gate for a plurality of proximal electronic signals. The plurality of proximal electronic signals is a group of electronic signals directly around the scanning device. Next, the plurality of proximal electronic signals is filtered to identify only passengers, or individuals registered with the present invention. Specifically, each of the plurality of proximal electronic signals is compared against the authentic electronic signal for each of the plurality of user accounts to compile a set of closest user accounts; wherein the authentic signal from the set of closest user accounts matches a corresponding signal from the plurality of proximal electronic signals. The set of closest user accounts is then organized based on proximity to the scanning device. First, a signal strength for the authentic electronic signal of each within the set of closest user accounts is measured by the scanning device. The signal strength refers to the transmitter power output as received by scanning device. Next, the set of closest user accounts are ordered based on the signal strength associated with the corresponding authentic electronic signal by the remote server. Finally, the set of closest user accounts is graphically displayed by the display device for the security personal to be utilized for a variety of means.

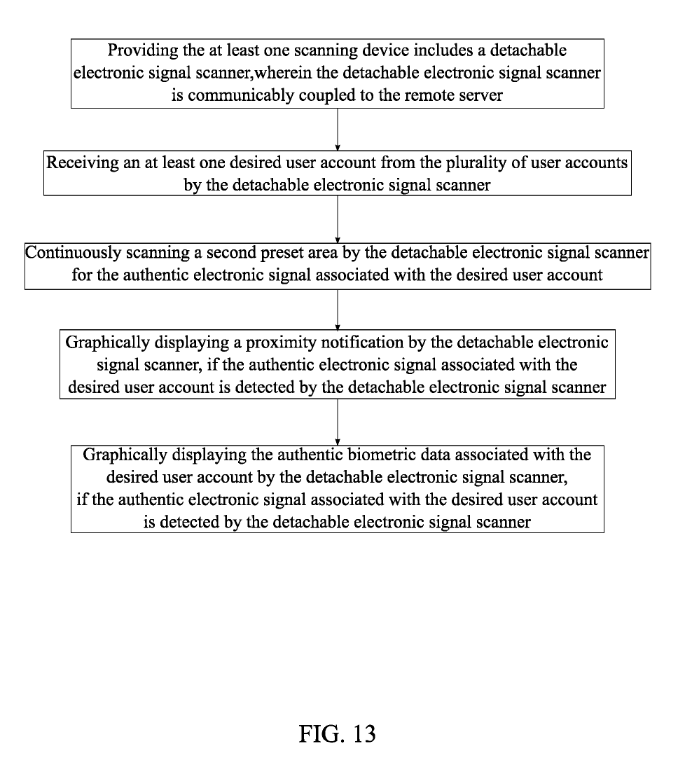

In one embodiment, referring to FIG. 13, the present invention is used to search and find specific individuals. For this, the at least one scanning device includes a detachable electronic signal scanner that is communicably coupled to the remote server. The detachable electronic signal scanner allows a security personnel to be mobile while searching for a specific individual. First, an at least one desired user account from the plurality of user accounts is received by the detachable electronic signal scanner. This may be an individual that is lost, late, needed for additional information, or needed for other reasons based on security personal. Once the desired user account is received or entered, the detachable electronic signal scanner continuously scans a second preset area for the authentic electronic signal associated with the desired user account. The second preset area depicts the area directly around the detachable electronic scanner. If the authentic electronic signal associated with the desired user account is detected by the detachable electronic signal scanner, then a proximity notification is graphically displayed by the detachable electronic signal scanner. To further aid the security personnel in identifying the desired user account, the authentic biometric data associated with the desired user account is graphically displayed by the detachable electronic signal scanner, if the authentic electronic signal associated with the desired user account is detected. This provides the security personnel with a means of easily identifying the individual associated with the desired user account.

Although the invention has been explained in relation to its preferred embodiment, it is to be understood that many other possible modifications and variations can be made without departing from the spirit and scope of the invention as hereinafter claimed.

What is claimed is:

1. A method for implementing user biometrics as a boarding-pass for public transportation comprising the steps of:
(A) providing an at least one remote server managing a plurality of user accounts, wherein each of the plurality of user accounts is associated with authentic biometric data, an at least one authentic electronic signal, and boarding-pass data;
(B) providing each user account being associated with an at least one portable electronic device, wherein the portable electronic device emits the authentic electronic signal;
(C) providing the remote server manages an at least one access gate, wherein the access gate includes an at least one scanning device and is associated with a gate itinerary and a set of scheduling requirements;
(D) receiving entrant biometric data through the scanning device;
(E) receiving an entrant electronic signal through the scanning device;
(F) comparing the entrant biometric data against the authentic biometric data for each of the user accounts in order to identify a matching account from the plurality of user accounts;
(G) comparing the boarding-pass data of the matching account to the gate itinerary with the remote server in order to identify shared scheduling data between the boarding-pass data of the matching account and the gate itinerary;
(H) sending a confirmation notification from the remote server to the access gate, if the shared scheduling data meets the set of scheduling requirements, and if the entrant electronic signal matches the authentic electronic signal of the matching account;

2. The method for implementing user biometrics as a boarding-pass for public transportation as claimed in claim 1 comprising the steps of:
sending an error notification from the remote server to the access gate after step (H), if the shared scheduling data does not meet the set of scheduling requirements.

3. The method for implementing user biometrics as a boarding-pass for public transportation as claimed in claim 1 comprising the steps of:
sending an error notification from the remote server to the access gate after step (H), if the entrant electronic signal does not match the authentic electronic signal of the matching account.

4. The method for implementing user biometrics as a boarding-pass for public transportation as claimed in claim 1 comprising the steps of:
providing an at least one registration kiosk, wherein the registration kiosk includes a fingerprint reader;
prompting, by the registration kiosk, an arbitrary account from the plurality of user accounts to enter authentic biometrics during step (A);
receiving a fingerprint image through the fingerprint reader;
extracting unique fingerprint identifiers from the fingerprint image with the registration kiosk; and
storing, by the remote server, the unique fingerprint identifiers as the authentic biometric data associated with the arbitrary account.

5. The method for implementing user biometrics as a boarding-pass for public transportation as claimed in claim 1 comprising the steps of:
providing an at least one registration kiosk, wherein the registration kiosk includes a digital camera;
prompting, by the registration kiosk, an arbitrary account from the plurality of user accounts to enter authentic biometrics during step (A);
receiving a facial digital image through the digital camera;
extracting unique facial identifiers from the digital image with the registration kiosk; and
storing, by the remote server, the unique facial identifiers as the authentic biometric data associated with the arbitrary account.

6. The method for implementing user biometrics as a boarding-pass for public transportation as claimed in claim 1 comprising the steps of:
providing an at least one registration kiosk, wherein the registration kiosk includes a barcode scanner;
prompting, by the registration kiosk, an arbitrary account from the plurality of user accounts to scan a boarding-pass ticket during step (A);
receiving boarding information through the barcode scanner, wherein the boarding information is encoded on the boarding-pass ticket; and
storing, by the remote server, the boarding information as the boarding-pass data associated with the arbitrary account.

7. The method for implementing user biometrics as a boarding-pass for public transportation as claimed in claim 1 comprising the steps of:
providing user identification (ID) information for each of the plurality of user accounts;
retrieving scanned ID information from a register ID document through the registration kiosk; and
comparing the scanned ID information to the user ID information for each of the user accounts in order to verify the user ID information of an arbitrary account with the scanned ID information during step (A).

8. The method for implementing user biometrics as a boarding-pass for public transportation as claimed in claim 1 comprising the steps of:
providing a departure time for a scheduled transport route within the boarding-pass data of the matching account;
providing a departure time for the scheduled transport route within the gate itinerary;
recording a current timestamp during step (D);
generating an acceptable tardiness window relative to the current timestamp;
designating the departure time of the matching account and the departure time from the gate itinerary as the shared scheduling data during step (G),
if the departure time of the matching account occurs before or during the acceptable tardiness window, and
if the departure time from the gate itinerary occurs before or during the acceptable tardiness window; and
fulfilling one of the scheduling requirements during step (H),
if the departure time of the matching account and the departure time of the gate itinerary are designated as the shared scheduling data.

9. The method for implementing user biometrics as a boarding-pass for public transportation as claimed in claim 1 comprising the steps of:
providing route ID data for a scheduled transport route within the boarding pass-data of the matching account;
providing route ID data for the scheduled transport route within the gate itinerary;
designating the route ID data of the matching account and the route ID data of the gate itinerary as the shared scheduling data during step (G),
if the route ID data of the gate itinerary matches the route ID data of the matching account; and
fulfilling one of the scheduling requirements during step (H),
if the route ID data of the matching account and the route ID data of the gate itinerary are designated as the shared scheduling data.

10. The method for implementing user biometrics as a boarding-pass for public transportation as claimed in claim 1 comprising the steps of:
providing an at least one registration kiosk, wherein the registration kiosk includes an electronic signal scanner;
prompting, by the registration kiosk, an arbitrary account from the plurality of user accounts to enter the authentic electronic signal during step (B);
scanning the portable electronic device associated with the arbitrary account with the electronic signal scanner to identify a digital signal; and
storing, by the remote server, the digital signal as the authentic electronic signal associated with the arbitrary account.

11. The method for implementing user biometrics as a boarding-pass for public transportation as claimed in claim 1 comprising the steps of:
providing the access gate includes a display device;
scanning, by the scanning device, a first preset area around the access gate for a plurality of proximal electronic signals;
comparing each of the plurality of proximal electronic signals against the authentic electronic signal for each of the plurality of user accounts to compile a set of closest user accounts, wherein the authentic electronic signal from the set of closest user accounts matches a corresponding signal from the plurality of proximal electronic signals;
measuring a signal strength for the authentic electronic signal of each within the set of closest user accounts with the scanning device;
ordering the set of closest user accounts based on the signal strength associated with the corresponding authentic electronic signal by the remote server; and
graphically displaying the set of closest user accounts by the display device.

12. The method for implementing user biometrics as a boarding-pass for public transportation as claimed in claim 1 comprising the steps of:
providing the at least one scanning device includes a detachable electronic signal scanner, wherein the detachable electronic signal scanner is communicably coupled to the remote server;
receiving an at least one desired user account from the plurality of user accounts by the detachable electronic signal scanner;
continuously scanning a second preset area by the detachable electronic signal scanner for the authentic electronic signal associated with the desired user account;
graphically displaying a proximity notification by the detachable electronic signal scanner, if the authentic electronic signal associated with the desired user account is detected by the detachable electronic signal scanner; and
graphically displaying the authentic biometric data associated with the desired user account by the detachable electronic signal scanner, if the authentic electronic signal associated with the desired user account is detected by the detachable electronic signal scanner.

13. The method for implementing user biometrics as a boarding-pass for public transportation as claimed in claim 1 comprising the steps of:
comparing the entrant electronic signal against the authentic electronic signal of the matching account during step (H) to verify the matching account;
sending the confirmation notification from the remote server to the access gate, if the matching account is verified; and
sending an error notification from the remote server to the access gate, if the matching account is not verified.
